(19) United States
(12) Patent Application Publication
(10) Pub. No.: US 2012/0084539 A1
(43) Pub. Date: Apr. 5, 2012

(54) METHOD AND SYTEM FOR PREDICATE-CONTROLLED MULTI-FUNCTION INSTRUCTIONS

(76) Inventors: Lars S. NYLAND, Carrboro, NC (US); John R. Nickolls, Los Altos, CA (US); Kathleen Elliott Nickolls, Los Altos, CA (US)

(21) Appl. No.: 13/247,833

(22) Filed: Sep. 28, 2011

Related U.S. Application Data
(60) Provisional application No. 61/387,914, filed on Sep. 29, 2010.

(51) Int. Cl. G06F 9/30

(52) U.S. Cl. 712/229; 712/E09.016

(57) ABSTRACT

Techniques are disclosed for executing conditional computer instructions in an efficient manner that reduces bubbles and idle states. In one embodiment, dual-function instruction execution is disclosed where the dual-function instruction has two possible functions (or operations), the choice of which is controlled by a predicate value with a true or false value. Among other things, the disclosed techniques provide dynamic control for choosing which operation to execute leading to more efficiently executed code.

### CROSS-REFERENCE TO RELATED APPLICATIONS

This application claims benefit of United States provisional patent application entitled “Predicate-Controlled Dual—Function Instructions,” filed on Sep. 29, 2010 and having a Ser. No. 61/387,914.

### BACKGROUND OF THE INVENTION

1. Field of the Invention

Embodiments of the present invention generally relate to methods for executing instructions on one or more digital processors.

2. Description of the Related Art

Most computer programs contain code which is executed under specific conditions depending on factors which cannot be determined a priori. Because many processors execute instructions in series, a traditional solution is to insert branch instructions that allow a program to conditionally branch to a different section of code. This was adequate until the advent of instruction pipelining, a method which is slowed by these types of branches but that provides other computational advantages.

With branch predication, all possible branch paths are executed where the result from the correct path is kept and all others are thrown away. Each instruction is associated with a predicate and that instruction is only executed if the associated predicate is true.

Besides eliminating branches, less code is needed with branch predication, provided the architecture provides predicated instructions. A primary purpose of predication is to avoid jumps over very small sections of program code, increasing the effectiveness of pipelined execution and avoiding problems with the cache. Elimination of unnecessary branch instructions can make the execution of necessary branches faster by lessening the load on branch prediction mechanisms.

A drawback of predication is that it requires increased encoding space. In typical implementations, every instruction reserves a bitfield for the predicate specifying whether that instruction should have an effect. When available memory is limited, as on embedded devices, this space cost can be prohibitive. Predication also complicates the hardware by adding levels of logic to critical paths and may also degrade clock speed. Because a predicated block includes cycles for all operations, shorter paths may actually take longer to execute.

Predication is most effective when paths are balanced or when the longest path is the most frequently executed; but determining such a path is difficult at compile time.

In the prior art, therefore, the ability to execute different operations required either a branch or predication that enables or disables an instruction. In either case, performance is degraded, especially for Single Instruction Multi-Thread (SIMT) or Single Instruction Multi-Data (SIMD) parallel computers where multiple threads of control are running simultaneously.

Disadvantageously, empty bubbles are introduced into the pipeline (with branches) or instructions that are predicated off consume issue slots with no effective work. For a typical computer, a compiler would generate code for the expression in the if-statement, for example, and then use branches to jump to the correct block of code. If the compiler is targeting a machine with predicate registers, code is generated for both the true and false clauses, with predication used to enable/disable the appropriate instructions. On parallel computers, all of the instructions that are generated for the true and false clauses will be executed, reducing the efficiency of execution to at most 50%.

As the foregoing illustrates, there is a need in the art for more efficient methods for implementing conditional computer instructions.

### SUMMARY OF THE INVENTION

An embodiment of the present invention includes a method for executing conditional computer instructions in an efficient manner that reduces bubbles and idle states. In an embodiment, a method for executing a dual-function instruction is disclosed where the dual-function instruction has two possible functions (or operations), the choice of which is controlled by a predicate value with a true or false value. In an embodiment of the invention, each of the dual functions has certain substantially similar characteristics such that their execution presents a similar load on a processor. Among other things, the present invention provides dynamic control for choosing which operation to execute leading to more efficiently executed code.

In another embodiment of the invention that is implemented on a parallel processing computer, multiple threads compute their own true/false values, for example, so as to allow control of which operation is executed per thread without the performance penalties that are incurred using traditional methods when threads need to execute diverse operations. By combining commonly occurring pairs of instructions that present similar computational loads into a single instruction, the processing pipeline is continuously filled, with all parallel threads continuing to make progress.

The present invention, therefore, avoids empty bubbles that are traditionally introduced into a pipeline such as with the implementation of branches. The present invention also avoids the consumption of issue slots that perform no effective work when an instruction is traditionally predicated off.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing subsystem for the computer system of FIG. 1, according to one embodiment of the present invention;

FIG. 3A is a block diagram of a GPC within one of the PPUs of FIG. 2, according to one embodiment of the present invention;

FIG. 3B is a block diagram of a partition unit within one of the PPUs of FIG. 2, according to one embodiment of the present invention;

FIG. 3C is a block diagram of a portion of the SPM of FIG. 3A, according to one embodiment of the present invention; and

FIG. 4 is a more detailed diagram of the predicate register file of FIG. 3C, according to one embodiment of the present invention.

FIG. 5 is a flowchart for a method according to an embodiment of the invention for executing a dual-function instruction.

FIG. 6 is a flowchart for a method according to an embodiment of the invention for executing a dual-function instruction on a dual-processor system.

FIG. 7 is a flowchart for a method according to an embodiment of the invention for executing a dual-function instruction on a dual-processor system.

FIG. 8 is a flowchart for a method according to an embodiment of the invention for executing a multi-function instruction on a multi-processor system.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

Among other things, the present invention relates to methods, techniques, and algorithms that are intended to be implemented in a digital computer system. By way of overview that is not intended to be limiting, a digital computer system will be described. Such a digital computer or embedded device is well-known in the art and may include variations of the below-described system.

### System Overview

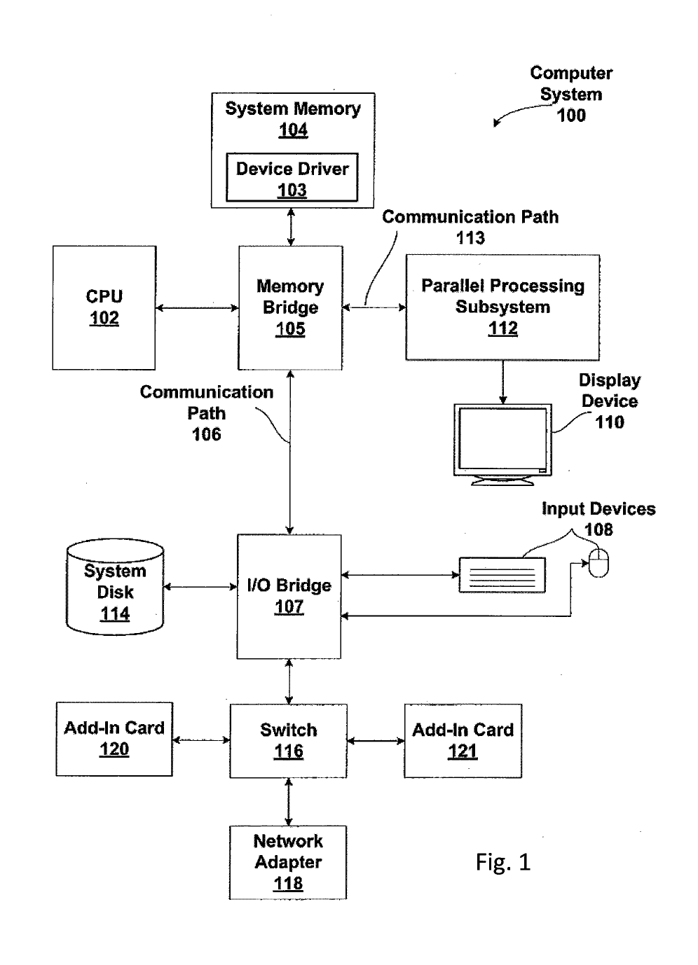

FIG. 1 is a block diagram illustrating a computer system 100 configured to implement one or more aspects of the present invention. Computer system 100 includes a central processing unit (CPU) 102 and a system memory 104 communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to memory bridge 105 via a bus or other communication path 113 (e.g., a PCI Express, Accelerated Graphics Port, or HyperTransport link); in one embodiment parallel processing subsystem 112 is a graphics subsystem that delivers pixels to a display device 110 (e.g., a conventional CRT or LCD based monitor). A system disk 114 is also connected to I/O bridge 107. A switch 116 provides connections between I/O bridge 107 and other components such as a network adapter 118 and various add-in cards 120 and 121. Other components (not explicitly shown), including USB or other port connections, CD drives, DVD drives, film recording devices, and the like, may also be connected to I/O bridge 107. Communication paths interconnecting the various components in FIG. 1 may be implemented using any suitable protocols, such as PCI (Peripheral Component Interconnect), PCI-Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements, such as the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip. Large embodiments may include two or more CPUs 102 and two or more parallel processing systems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

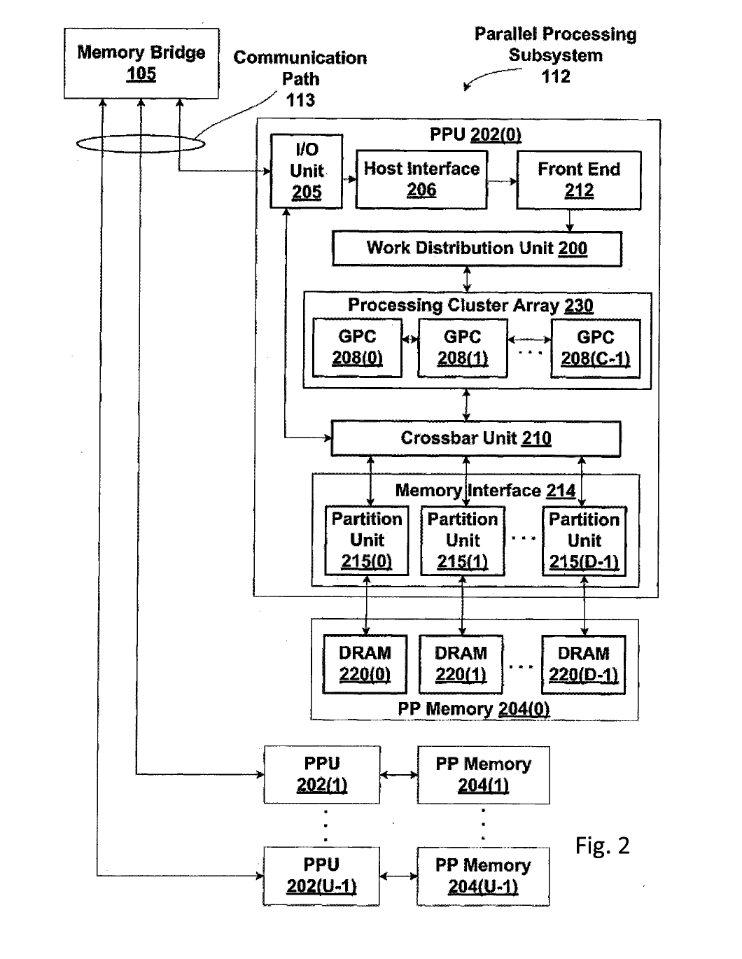

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1, in some embodiments, some or all of PPUs 202 in parallel processing subsystem 112 are graphics processors with rendering pipelines that can be configured to perform various tasks related to generating pixel data from graphics data supplied by CPU 102 and/or system memory 104 via memory bridge 105 and bus 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have its own dedicated parallel processing memory device(s) or no dedicated parallel processing memory device(s). One or more PPUs 202 may output data to display device 110 or each PPU 202 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a pushbuffer (not explicitly shown in either FIG. 1 or FIG. 2) that may be located in system memory 104, parallel processing memory 204, or another storage location accessible to both CPU 102 and PPU 202. PPU 202 reads the command stream from the pushbuffer and then executes commands asynchronously relative to the operation of CPU 102.

Referring back now to FIG. 2, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, one or all elements of PPU 202 may be integrated on a single chip with CPU 102.

In one embodiment, communication path 113 is a PCI-EXPRESS link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the work specified by the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C;:::: 1. Each GPC 208 is capable of executing a large number (e.g., hundreds or thousands) of threads concurrently, where each thread is an instance of a program. In various applications, different GPCs 208 may be allocated for processing different types of programs or for performing different types of computations. For example, in a graphics application, a first set of GPCs 208 may be allocated to perform tessellation operations and to produce primitive topologies for patches, and a second set of GPCs 208 may be allocated to perform tessellation shading to evaluate patch parameters for the primitive topologies and to determine vertex positions and other per-vertex attributes. The allocation of GPCs 208 may vary dependent on the workload arising for each type of program or computation.

GPCs 208 receive processing tasks to be executed via a work distribution unit 200, which receives commands defining processing tasks from front end unit 212. Processing tasks include indices of data to be processed, e.g., surface (patch) data, primitive data, vertex data, and/or pixel data, as well as state parameters and commands defining how the data is to be processed (e.g., what program is to be executed). Work distribution unit 200 may be configured to fetch the indices corresponding to the tasks, or work distribution unit 200 may receive the indices from front end 212. Front end 212 ensures that GPCs 208 are configured to a valid state before the processing specified by the pushbuffers is initiated.

When PPU 202 is used for graphics processing, for example, the processing workload for each patch is divided into approximately equal sized tasks to enable distribution of the tessellation processing to multiple GPCs 208. A work distribution unit 200 may be configured to produce tasks at a frequency capable of providing tasks to multiple GPCs 208 for processing. By contrast, in conventional systems, processing is typically performed by a single processing engine, while the other processing engines remain idle, waiting for the single processing engine to complete its tasks before beginning their processing tasks. In some embodiments of the present invention, portions of GPCs 208 are configured to perform different types of processing. For example a first portion may be configured to perform vertex shading and topology generation, a second portion may be configured to perform tessellation and geometry shading, and a third portion may be configured to perform pixel shading in screen space to produce a rendered image. Intermediate data produced by GPCs 208 may be stored in buffers to allow the intermediate data to be transmitted between GPCs 208 for further processing.

Memory interface 214 includes a number D of partition units 215 that are each directly coupled to a portion of parallel processing memory 204, where D 2:1. As shown, the number of partition units 215 generally equals the number of DRAM 220. In other embodiments, the number of partition units 215 may not equal the number of memory devices. Persons skilled in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Anyone of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments PPU 202 may be integrated into a bridge chip or processor chip or provided as a discrete chip with a high-speed link (e.g., PCI-EXPRESS) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

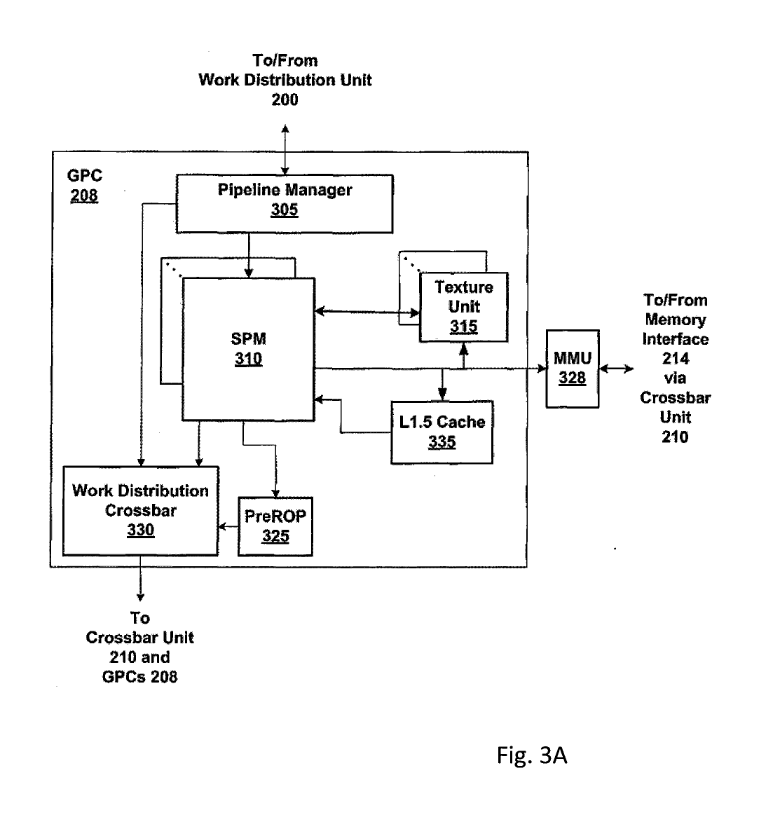

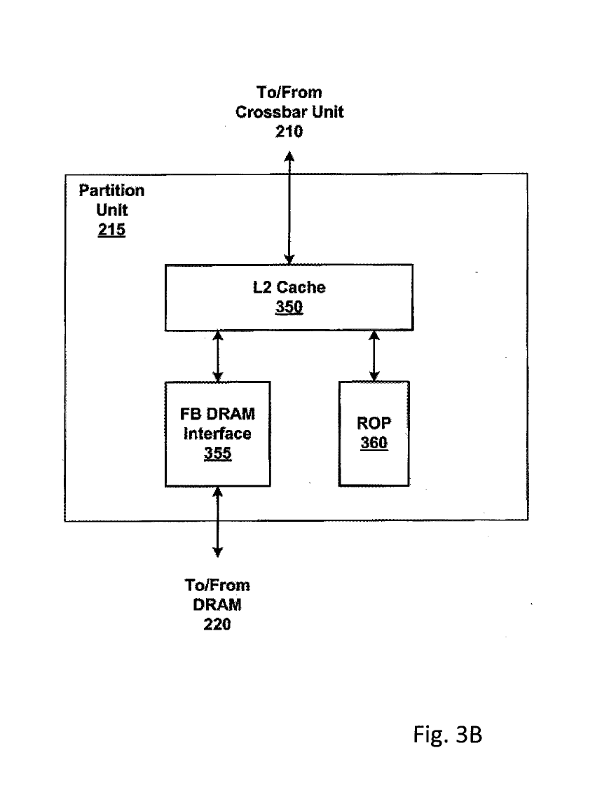

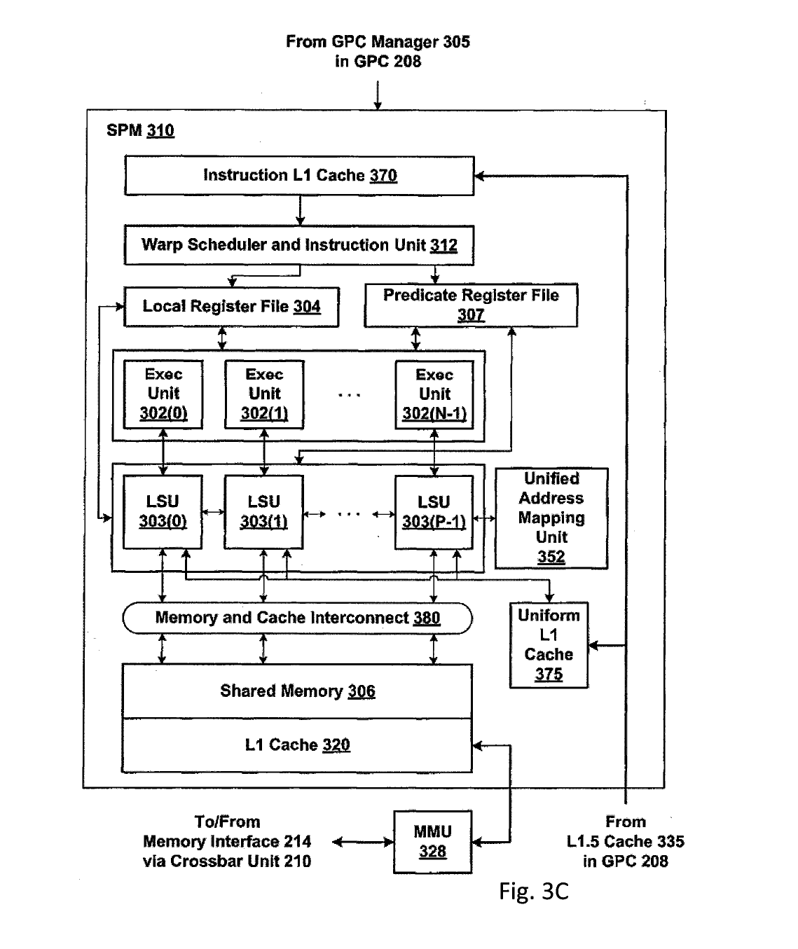

FIG. 3A is a block diagram of a GPC 208 within one of the PPUs 202 of FIG. 2, according to one embodiment of the present invention. Each GPC 208 may be configured to execute a large number of threads in parallel, where the term “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within each one of the GPCs 208. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

Operation of GPC 208 is advantageously controlled via a pipeline manager 305 that distributes processing tasks to SIMT parallel thread processors called streaming multiprocessors (SPMs) 310. Pipeline manager 305 may also be configured to control a work distribution crossbar 330 by specifying destinations for processed data output by SPMs 310.

In one embodiment, each GPC 208 includes a number M of SPMs 310, where M≧1, each SPM 310 configured to process one or more thread groups. Also, each SPM 310 advantageously includes an identical set of functional execution units (e.g., arithmetic logic units, and load-store units, shown as Exec units 302 and LSUs 303 in FIG. 3C) that may be pipelined, allowing a new instruction to be issued before a previous instruction has finished, as is known in the art. Any combination of functional execution units may be provided. In one embodiment, the functional units support a variety of operations including integer and floating point arithmetic (e.g., addition and multiplication), comparison operations, Boolean operations (AND, OR, XOR), bit-shifting, and computation of various algebraic functions (e.g., planar interpolation, trigonometric, exponential, and logarithmic functions, etc.); and the same functional-unit hardware can be leveraged to perform different operations.

The series of instructions transmitted to a particular GPC 208 constitutes a thread, as previously defined herein, and the collection of a certain number of concurrently executing threads across the parallel processing engines (not shown) within an SPM 310 is referred to herein as a “warp” or “thread group.” As used herein, a “thread group” refers to a group of threads concurrently executing the same program on different input data, with one thread of the group being assigned to a different processing engine within an SPM 310. A thread group may include fewer threads than the number of processing engines within the SPM 310, in which case some processing engines will be idle during cycles when that thread group is being processed. A thread group may also include more threads than the number of processing engines within the SPM 310, in which case processing will take place over consecutive clock cycles. Since each SPM 310 can support up to G thread groups concurrently, it follows that up to G*M thread groups can be executing in GPC 208 at any given time.

Additionally, a plurality of related thread groups may be active (in different phases of execution) at the same time within an SPM 310. This collection of thread groups is referred to herein as a “cooperative thread array” (“CIA”) or “thread array.” The size of a particular CTA is equal to m*k, where k is the number of concurrently executing threads in a thread group and is typically an integer multiple of the number of parallel processing engines within the SPM 310, and m is the number of thread groups simultaneously active within the SPM 310. The size of a CTA is generally determined by the programmer and the amount of hardware resources, such as memory or registers, available to the CTA.

Each SPM 310 contains an L1 cache (not shown) or uses space in a corresponding L1 cache outside of the SPM 310 that is used to perform load and store operations. Each SPM 310 also has access to L2 caches within the partition units 215 that are shared among all GPCs 208 and may be used to transfer data between threads. Finally, SPMs 310 also have access to off-chip “global” memory, which can include, e.g., parallel processing memory 204 and/or system memory 104. It is to be understood that any memory external to PPU 202 may be used as global memory. Additionally, an L1.5 cache 335 may be included within the GPC 208, configured to receive and hold data fetched from memory via memory interface 214 requested by SPM 310, including instructions, uniform data, and constant data, and provide the requested data to SPM 310. Embodiments having multiple SPMs 310 in GPC 208 beneficially share common instructions and data cached in L1.5 cache 335.

Each GPC 208 may include a memory management unit (MMU) 328 that is configured to map virtual addresses into physical addresses. In other embodiments, MMU(s) 328 may reside within the memory interface 214. The MMU 328 includes a set of page table entries (PTEs) used to map a virtual address to a physical address of a tile and optionally a cache line index. The MMU 328 may include address translation lookaside buffers (TLB) or caches which may reside within multiprocessor (SMP 310 or the L1 cache or GPC 208. The physical address is processed to distribute surface data access locality to allow efficient request interleaving among partition units. The cache line index may be used to determine whether or not a request for a cache line is a hit or miss.

In graphics and computing applications, a GPC 208 may be configured such that each SPM 310 is coupled to a texture unit 315 for performing texture mapping operations, e.g., determining texture sample positions, reading texture data, and filtering the texture data. Texture data is read from an internal texture L1 cache (not shown) or in some embodiments from the L1 cache within SPM 310 and is fetched from an L2 cache, parallel processing memory 204, or system memory 104, as needed. Each SPM 310 outputs processed tasks to work distribution crossbar 330 in order to provide the processed task to another GPC 208 for further processing or to store the processed task in an L2 cache, parallel processing memory 204, or system memory 104 via crossbar unit 210. A preROP (pre-raster operations) 325 is configured to receive data from SPM 310, direct data to ROP units within partition units 215, and perform optimizations for color blending, organize pixel color data, and perform address translations.

It will be appreciated that the core architecture described herein is illustrative and that variations and modifications are possible. Any number of processing units, e.g., SPMs 310 or texture units 315, preROPs 325 may be included within a GPC 208. Further, while only one GPC 208 is shown, a PPU 202 may include any number of GPCs 208 that are advantageously functionally similar to one another so that execution behavior does not depend on which GPC 208 receives a particular processing task. Further, each GPC 208 advantageously operates independently of other GPCs 208 using separate and distinct processing units, L1 caches, and so on.

FIG. 3B is a block diagram of a partition unit 215 within one of the PPUs 202 of FIG. 2, according to one embodiment of the present invention. As shown, partition unit 215 includes a L2 cache 350, a frame buffer (FB) DRAM interface 355, and a raster operations unit (ROP) 360. L2 cache 350 is a read/write cache that is configured to perform load and store operations received from crossbar unit 210 and ROP 360. Read misses and urgent writeback requests are output by L2 cache 350 to FB DRAM interface 355 for processing. Dirty updates are also sent to FB 355 for opportunistic processing. FB 355 interfaces directly with DRAM 220, outputting read and write requests and receiving data read from DRAM 220.

In graphics applications, ROP 360 is a processing unit that performs raster operations, such as stencil, z test, blending, and the like, and outputs pixel data as processed graphics data for storage in graphics memory. In some embodiments of the present invention, ROP 360 is included within each GPC 208 instead of partition unit 215, and pixel read and write requests are transmitted over crossbar unit 210 instead of pixel fragment data.

The processed graphics data may be displayed on display device 110 or routed for further processing by CPU 102 or by one of the processing entities within parallel processing subsystem 112. Each partition unit 215 includes a ROP 360 in order to distribute processing of the raster operations. In some embodiments, ROP 360 may be configured to compress z or color data that is written to memory and decompress z or color data that is read from memory.

Persons skilled in the art will understand that the architecture described in FIGS. 1, 2, 3A, and 3B in no way limits the scope of the present invention and that the techniques taught herein may be implemented on any properly configured processing unit, including, without limitation, one or more CPUs, one or more multi-core CPUs, one or more PPUs 202, one or more GPCs 208, one or more graphics or special purpose processing units, or the like, without departing the scope of the present invention.

In embodiments of the present invention, it is desirable to use PPU 122 or other processor(s) of a computing system to execute general-purpose computations using thread arrays. Each thread in the thread array is assigned a unique thread identifier (“thread 10”) that is accessible to the thread during its execution. The thread 10, which can be defined as a one-dimensional or multi-dimensional numerical value controls various aspects of the thread's processing behavior. For instance, a thread 10 may be used to determine which portion of the input data set a thread is to process and/or to determine which portion of an output data set a thread is to produce or write.

A sequence of per-thread instructions may include at least one instruction that defines a cooperative behavior between the representative thread and one or more other threads of the thread array. For example, the sequence of per-thread instructions might include an instruction to suspend execution of operations for the representative thread at a particular point in the sequence until such time as one or more of the other threads reach that particular point, an instruction for the representative thread to store data in a shared memory to which one or more of the other threads have access, an instruction for the representative thread to atomically read and update data stored in a shared memory to which one or more of the other threads have access based on their thread IDs, or the like. The CTA program can also include an instruction to compute an address in the shared memory from which data is to be read, with the address being a function of thread 10. By defining suitable functions and providing synchronization techniques, data can be written to a given location in shared memory by one thread of a CTA and read from that location by a different thread of the same CTA in a predictable manner. Consequently, any desired pattern of data sharing among threads can be supported, and any thread in a CTA can share data with any other thread in the same CTA. The extent, if any, of data sharing among threads of a CTA is determined by the CTA program; thus, it is to be understood that in a particular application that uses CTAs, the threads of a CTA might or might not actually share data with each other, depending on the CTA program, and the terms “CTA” and “thread array” are used synonymously herein.

FIG. 3C is a block diagram of the SPM 310 of FIG. 3A, according to one embodiment of the present invention. The SPM 310 includes an instruction L1 cache 370 that is configured to receive instructions and constants from memory via L1.5 cache 335. A warp scheduler and instruction unit 312 receives instructions and constants from the instruction L1 cache 370 and controls local register file 304 and SPM 310 functional units according to the instructions and constants. The SPM 310 functional units include N exec (execution or processing) units 302 and P load-store units (LSU) 303.

SPM 310 provides on-chip (internal) data storage with different levels of accessibility. Special registers (not shown) are readable but not writeable by LSU 303 and are used to store parameters defining each CTA thread's “position.” In one embodiment, special registers include one register per CTA thread (or per exec unit 302 within SPM 310) that stores a thread 10; each thread 10 register is accessible only by a respective one of the exec unit 302. Special registers may also include additional registers, readable by all CTA threads (or by all LSUs 303) that store a CTA identifier, the CTA dimensions, the dimensions of a grid to which the CTA belongs, and an identifier of a grid to which the CTA belongs. Special registers are written during initialization in response to commands received via front end 212 from device driver 103 and do not change during CTA execution.

A parameter memory (not shown) stores runtime parameters (constants) that can be read but not written by any CTA thread (or any LSU 303). In one embodiment, device driver 103 provides parameters to the parameter memory before directing SPM 310 to begin execution of a CTA that uses these parameters. Any CTA thread within any CTA (or any exec unit 302 within SPM 310) can access global memory through a memory interface 214. Portions of global memory may be stored in the L1 cache 320.

Local register file 304 is used by each CTA thread as scratch space; each register is allocated for the exclusive use of one thread, and data in any of local register file 304 is accessible only to the CTA thread to which it is allocated. Local register file 304 can be implemented as a register file that is physically or logically divided into P lanes, each having some number of entries (where each entry might store, e.g., a 32-bit word). One lane is assigned to each of the N exec units 302 and P load-store units LSU 303, and corresponding entries in different lanes can be populated with data for different threads executing the same program to facilitate SIMD execution. Different portions of the lanes can be allocated to different ones of the G concurrent thread groups, so that a given entry in the local register file 304 is accessible only to a particular thread. In one embodiment, certain entries within the local register file 304 are reserved for storing thread identifiers, implementing one of the special registers.

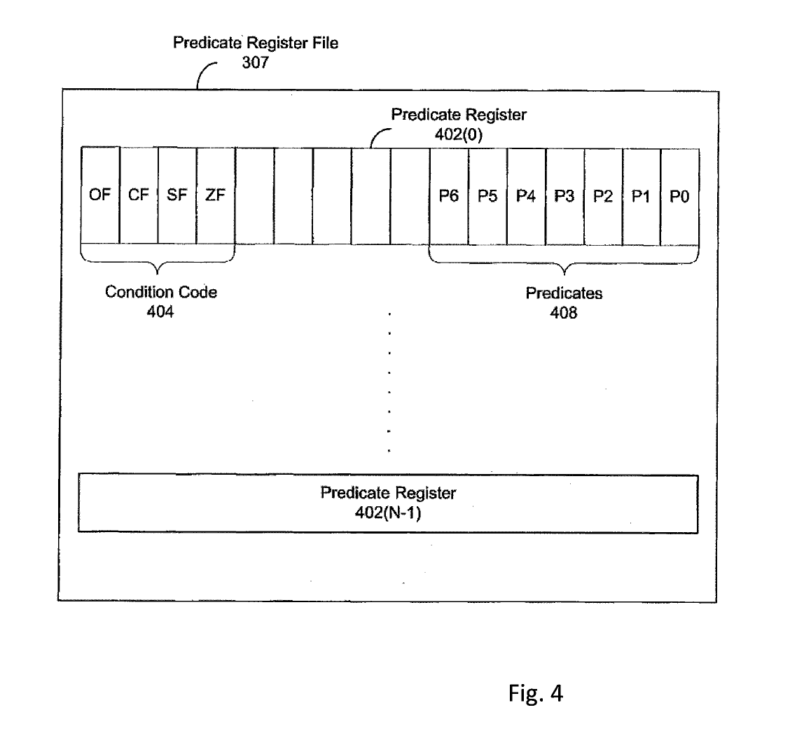

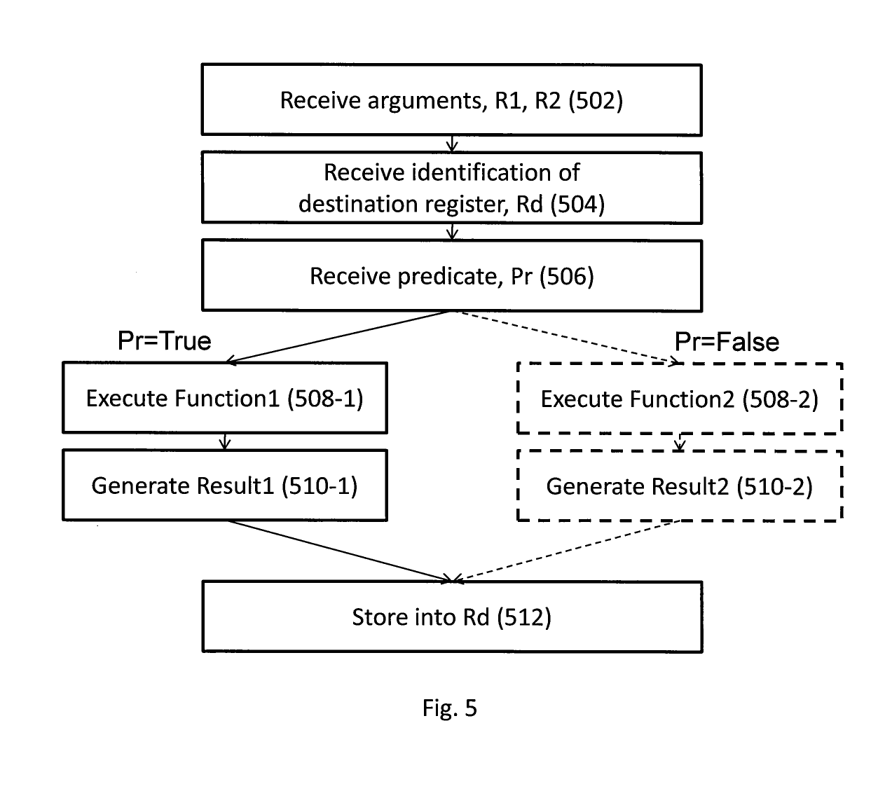

Predicate register file 307 includes predicate registers for each CTA thread. Predicate register file 307 is described in greater detail below with respect to FIGS. 4 and 5.

Shared memory 306 is accessible to all CTA threads (within a single CTA); any location in shared memory 306 is accessible to any CTA thread within the same CTA (or to any processing engine within SPM 310). Shared memory 306 can be implemented as a shared register file or shared on-chip cache memory with an interconnect that allows any processing engine to read from or write to any location in the shared memory. In other embodiments, shared state space might map onto a per-CIA region of off-chip memory, and be cached in L1 cache 320. The parameter memory can be implemented as a designated section within the same shared register file or shared cache memory that implements shared memory 306, or as a separate shared register file or on-chip cache memory to which the LSUs 303 have read-only access. In one embodiment, the area that implements the parameter memory is also used to store the CTA 10 and grid 10, as well as CTA and grid dimensions, implementing portions of the special registers. Each LSU 303 in SPM 310 is coupled to a unified address mapping unit 352 that converts an address provided for load and store instructions that are specified in a unified memory space into an address in each distinct memory space. Consequently, an instruction may be used to access any of the local, shared, or global memory spaces by specifying an address in the unified memory space.

FIG. 4 is a more detailed diagram of the predicate register file 307 of FIG. 3C, according to one embodiment of the present invention. As shown, the predicate register file 307 includes N different predicate registers 402. Each predicate register 402 is associated with a different thread executing within the SPM 310 on the execution units 302. For the purpose of discussion only, predicate register 402(0) is described below in greater detail. Predicate register 402(0) includes a condition code 404 and predicates 408.

The condition code 404 comprises four 1-bit condition code flags: OF (overflow flag), CF (carry flag), SF (sign flag), and ZF (zero flag). Within each thread the condition code may be optionally written by instructions; the condition code is typically written by integer and floating-point arithmetic instructions to indicate properties of the arithmetic result. The predicates 408 comprise seven 1-bit predicates that can be used by the thread associated with the predicate register 402(0). Each of the predicates PO-P6 in predicates 408 indicates one bit of state associated with the thread, where a value of 0 for a predicate indicates False and value of 1 indicates True. In addition to predicates PO-P6, a reserved instruction encoding for a True predicate, PT, whose value is always 1 is provided. Predicate PT does not require any per-thread state. Predicate PT may be used as an instruction source operand when a constant True predicate value is needed, and as an instruction destination operand when an instruction has no live-out predicate result; writes to PT are ignored.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

### Predicate-Controlled Multi-Function Instructions

An embodiment of the invention includes techniques for executing instructions on a computer processor. Appropriate computer processors include central processing units, parallel processing units, graphics processing units, and the like. Indeed, the techniques of the present invention can be implemented on thinner processors including, for example, ARM processors.

So as to facilitate the disclosure of the present invention, a dual-function instruction will first be described that is controlled by a 1-bit predicate. Embodiments of the present invention will then be described more generally for a multi-function instruction that is controlled by a multi-bit predicate of appropriate size. Those of ordinary skill in the art, however, will understand that the scope of the present invention is in no way limited by the disclosed examples.

Shown in FIG. 5 is a method according to an embodiment of the invention for executing a dual-function instruction that is controlled by a 1-bit predicate. In an embodiment, the dual-function instruction includes two functions that are complementary in certain common algorithms and that introduce similar computational loads on a processor. For example, to be described further below are examples of such dual function instructions that include a MINMAX instruction that alternatively performs a MIN or MAX operation as controlled by a predicate value. As will be shown, the alternative MIN and MAX functions are advantageously used in certain algorithms. Also, the MIN and MAX functions use the same arguments and introduce balanced loads on a digital processor. In another example, an ADDSUB instruction will be described that alternatively performs certain ADD or SUB instructions based on the state of the predicate. Although the method is described in conjunction with the various system representations set forth herein, persons skilled in the art will understand that any system that describes the method steps, in any order, falls within the scope of the present invention.

As shown in FIG. 5, at step 502, the method receives certain arguments, e.g., R1 and R2, to be used in a dual function instruction. The use of two arguments here is for exemplary purposes only. One of ordinary skill in the art would understand that other implementations of the present invention could use a different number of arguments.

An example of a dual-function instruction includes the MINMAX instruction to be described further below. For example, for the dual-function instruction MINMAX, the arguments R1 and R2 include numerical values for which a MIN or MAX operation may be alternatively performed.

At step 504, information is received regarding the location, destination register Rd, where the results of the dual-function instruction are to be stored. For example, in the MINMAX operation, the result of the desired MIN or MAX instruction would be written to the destination register Rd.

A predicate, Pr, is then received at step 506. For a dual-function instruction, the predicate is a 1-bit value in an embodiment of the invention. The predicate value indicates which of the two functions of the dual-function instruction are to be executed.

For example in an embodiment, where predicate Pr=1 (indicating a true value), steps 508-1 and 510-1 are performed. More particularly, at step 508-1 Function1, which is one function of the dual-function instruction, is executed and at step 510-1, a result is generated. The result of step 510-1 is then stored in step 512.

Alternatively, if predicate Pr=0 (indicating a false value), steps 508-1 and 510-1 are performed. More particularly, at step 508-2 Function2, which is a second function of the dual-function instruction, is executed and at step 510-2, a result is generated. The result of step 510-2 is then stored in step 512.

By combining commonly occurring and balanced pairs of instructions into a single dual-function instruction, the processing pipeline is continuously filled. As will be demonstrated below, the method for executing a multi-function instruction, such as a dual-function instruction, using a predicate can yield more efficient programming that reduces the disadvantageous effects of the prior art including bubbles, idle states, or the consumption of issue slots.

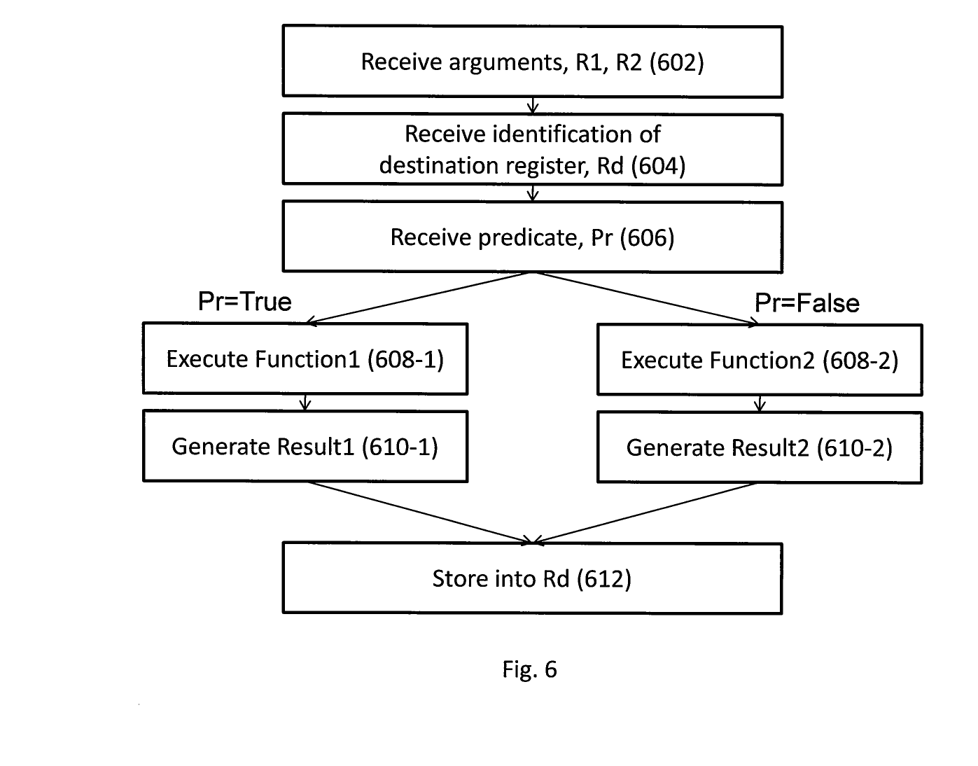

Embodiments of the present invention present further advantages when implemented in a multi-processor system, such as described above as well as other multi-processor systems that become available in the future. Shown in FIG. 6 is a method for implementing a dual-function instruction as controlled with a 1-bit predicate on a parallel processor such as, but not limited to, a dual-core CPU, PPU, or GPU. Although the method is described in conjunction with the various system representations set forth herein, persons skilled in the art will understand that any system that describes the method steps, in any order, falls within the scope of the present invention.

As shown in FIG. 6, at step 602, the method receives certain arguments, e.g., R1 and R2, to be used in a dual function instruction. For example, for the dual-function instruction MINMAX according to an embodiment of the invention, the arguments R1 and R2 include numerical values for which an MIN or MAX operation may be alternatively performed.

At step 604, information is received regarding the location, destination register Rd, where the results of the dual-function instruction are to be stored. For example, in the MINMAX operation, the result of the desired MIN or MAX instruction would be written to the destination register Rd.

A predicate, Pr, is then received at step 606. For a dual-function instruction, the predicate is a 1-bit value in an embodiment of the invention. The predicate value indicates which of the two functions of the dual-function instruction are to be stored.

In a parallel processing implementation, different processors (or cores) can implement different functions of the dual function instruction. For example in an embodiment, for predicate Pr=1 (indicating a true value), step 608-1 and 610-1 are performed by a first processor. More particularly, at step 608-1 Function1, which is one function of the dual-function instruction, is executed on a first processor and at step 610-1, a result is generated. Also, for predicate Pr=0 (indicating a false value), step 608-1 and 610-1 are performed by a second processor. More particularly, at step 608-2 Function2, which is second function of the dual-function instruction, is executed on the second processor and at step 610-2, a result is generated. In an embodiment, the dual functions represent a balanced load on the processors and are, therefore, executed in substantially the same amount of time without creating bubbles or other inefficient processor conditions.

At step 612, the desired result of either step 610-1 or step 610-2 is stored in step 612 into Rd depending on the predicate, Pr.

This embodiment provides advantages over the prior art because, among other things, the branches of the method of FIG. 6 are performed more efficiently. The parallel processing pipeline is continuously filled without inefficient bubbles or issue slots. Executing a multi-function instruction, such as a dual-function instruction, using a predicate control reflected in FIG. 6 can yield more efficient programming that reduces the disadvantageous effects of the prior art including bubbles, idle states, or the consumption of issue slots.

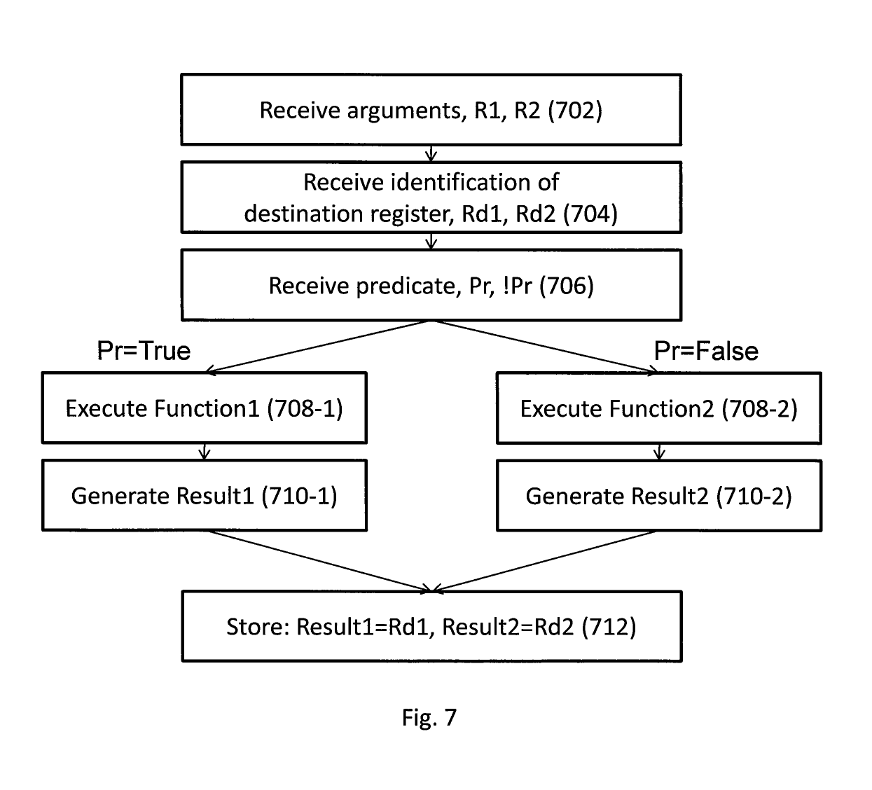

Embodiments of the present invention provide further advantages where it is a priori known that both functions of a dual-function instruction are to be performed on a multi-processor system. Shown in FIG. 7 is a method for implementing a dual-function instruction as controlled with a 1-bit predicate where the results of each function of the dual-function instruction are used. Although the method is described in conjunction with the various system representations set forth herein, persons skilled in the art will understand that any system that describes the method steps, in any order, falls within the scope of the present invention. For example, the method can be implemented on a parallel processor such as, but not limited to, a dual-core CPU, PPU, or GPU.

As shown in FIG. 7, at step 702, the method of the present invention receives certain arguments, e.g., R1 and R2, to be used in a dual function instruction. At step 704, information is received regarding the location, destination registers, Rd1 and Rd2, where the results of the dual-function instruction are to be stored. A predicate, Pr, is then received at step 706

In the method of FIG. 7, both functions of the dual-function instruction are to be executed as indicated by the variables Pr and !Pr, where !Pr is the complement of Pr. In a parallel processing implementation, different processors (or cores) implement different functions of the dual function instruction. For example in an embodiment, for predicate Pr, steps 708-1 and 710-1 are performed by a first processor. More particularly, at step 708-1 Function1, which is one function of the dual-function instruction, is executed on a first processor and at step 710-1, a result is generated. Also, for predicate !Pr, step 708-1 and 710-1 are performed by a second processor. More particularly, at step 708-2 Function2, which is second function of the dual-function instruction, is executed on the second processor and at step 710-2, a result is generated. In an embodiment, the dual functions represent a balanced load on the processors and are, therefore, executed in substantially the same amount of time without creating bubbles or other inefficient processor conditions.

In the method of FIG. 7, the results from both instructions of the dual-function are desired and, therefore, stored into the appropriate registers at step 712. This embodiment provides further advantages over the prior art because, among other things, the processing of both branches are utilized.

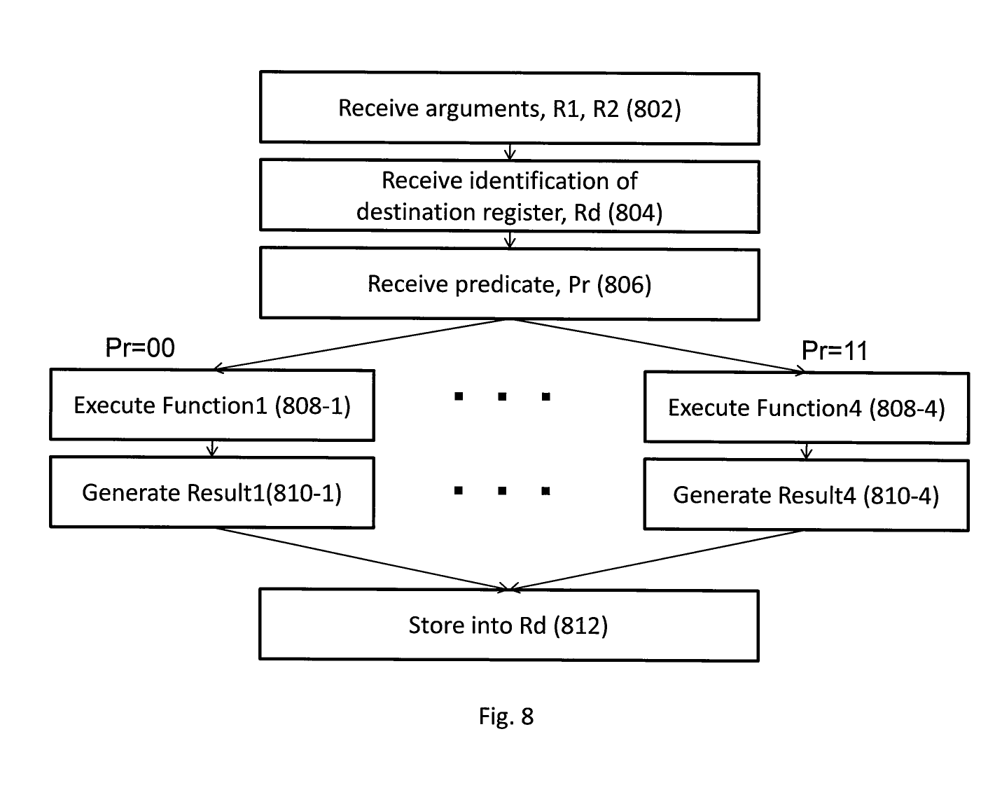

Embodiments of the present invention are not limited to dual-function instructions nor to dual core or dual processor implementations. Indeed, as shown in FIG. 8, the present invention can be extended to general multi-function instructions. The method of FIG. 8 is, for example, an extension of the method of FIG. 6; whereas, the method of FIG. 6 implemented two functions, the method of FIG. 8 implements four functions. To do so, the predicate, Pr, is extended to two bits and four branches of instructions are executed. The method of FIG. 8 can be implemented, for example, in a computed goto algorithm.

Many other modifications are possible. For example, the number of arguments is not limited to two. Likewise, the results to be stored are not limited. These and other modifications would be well understood to those of ordinary skill in the art.

To be described now are certain implementations that will add to the understanding of embodiments of the present invention. In a first implementation a dual-function instruction, MINMAX, will be described.

The MINMAX dual-function instruction is used to compute either the minimum or maximum of two input values. The choice of which operation to execute is controlled by a predicate value (a true or false, stored in a predicate register such as described for step 506 of FIG. 5). The general form of the dual-function instruction is:
MINMAX Rdest, RsrcA, RsrcB, Px;
   where RsrcA and RsrcB are the registers being compared (see, for example, step 502 of FIG. 5), Rdest is the destination register where the result is written (see, for example, step 504 of FIG. 5), and Px is a predicate register (see, for example, step 506 of FIG. 5) that controls whether the operation performed is MIN(RsrcA, RsrcB) or MAX(RsrcA, RsrcB).

The dual-function instruction MINMAX provides programming advantages in certain comparison algorithms. For example, at the core of many comparison algorithms is the following construct:

```
if (condition)
    x = max(a, b);
else
    x = min(a, b);
```

For a typical computer, the compiler generates code for the expression in the if-statement and then uses branches to jump to the correct block of code. If the compiler is targeting a machine with predicate registers, code is generated for both the true and false clauses, with predication used to enable/disable the appropriate instructions. On parallel computers, all of the instructions that are generated for the true and false clauses will be executed, reducing the efficiency of execution to at most 50%.

With the MINMAX instruction, the conditional expression is computed as usual, setting a predicate value, followed by all threads executing a MINMAX instruction using the previously computed predicate value. On a multi-threaded computer (such as those built by NVIDIA; see, for example, FIGS. 6 and 7), all concurrent threads execute the instruction simultaneously with some computing the max( ) while others compute the min( ) all concurrently. Advantageously, the number of bubbles, branches, and alternation of predicated execution is reduced. The incidence of idle threads is also reduced, so performance is improved.

Three forms of the MINMAX instruction have been implemented. One is for integer operations, called IMNMX, and the other two are for floating-point values, called FMNMX and DMNMX, for single and double-precision operations, respectively. They have the form:
IMNMX Rd, Ra, Rb, Py; # both signed and unsigned integers
FMNMX Rd, Ra, Rb, Py; # fp32 minmax
DMNMX Rd, Ra, Rb, Py; # fp64 minmax

The instructions compute the minimum of Ra and Rb when the predicate Py is false, and the maximum of Ra and Rb when Py is true. The result is stored in Rd. Full descriptions of the three Fermi instructions are included as appendices to the present disclosure.

Another implementation provides advantages in certain bitonic sort operations for parallel computers. Bitonic sort provides for fast sorting routines for parallel computers. At the core of the algorithm is the following construct:

```
if (dir) {
    u = min(a[i], a[j]);
    v = max(a[i], a[j]);
} else {
    u = max(a[i], a[j]);
    v = min(a[i], a[j]);
}
a[i] = u;
a[j] = v;
```

A difference in computing the value of u is whether it is the minimum or maximum of the two input values, the choice of which is controlled by the true/false value dir. With the MINMAX instruction as an implementation of the present invention, this results in a single instruction to assign each of u and v a value, as in:
IMNMX R0, R1, R2, !P1;
IMNMX R3, R1, R2, P1;
   where R0 is being used for the variable u, R3 holds v, R1 has the value loaded from memory location represented by a[i], R2 has the value of a[j], and P1 is a true/false predicate representing whether dir is true or false. The “!” complements the predicate value.

The chart below provides a comparison of the code generated both with and without the MINMAX instruction. Each example uses an ISETP instruction to set the predicate register, and then the predicate is used in three different ways. In the code in the left column, branch (BRA) instructions are used to jump to the correct code. The code in the center column uses the predicate to enable or disable the two choices of using MIN and MAX instructions. The code in the right column uses two MINMAX instructions to implement both the true and false sections of the if-statement.

| Without MINMAX, | | Without MINMAX, | | |
|---|---|---|---|---|
| using branch instructions | | using predication | | With MINMAX |
| | ISETP P1, . . . | | ISETP P1, . . . | ISETP P1, . . . |
| @!P1 | BRA L1 | @P1 | IMIN R0, . . . | IMNMX R0, . . . , !P1 |
| | IMIN R0, . . . | @P1 | IMAX R3, . . . | IMNMX R3, . . . , P1 |
| | IMAX R3, . . . | @!P1 | IMAX R0, . . . | |
| | BRA L2 | @!P1 | IMIN R3, . . . | |
| L1: | | | | |
| | IMAX R0, . . . | | | |
| | IMIN R3, . . . | | | |

L2: . . .

With conditional branches (left column of table), the body of the if-statement requires 6 instructions. Using predication (center column), only 4 instructions are required. But when MINMAX instructions are used (right column), only 2 instructions are needed. When executed millions of times in a bitonic sort operation the differences represented in the table result in a substantial performance boost for the method of the present invention.

Other pairings of instructions are also possible. For instance, CORDIC algorithms for implementing complex functions (such as division, square root, sine, cosine, tangent, and logarithm functions) often have the programming construct:

```
if (z < 0) {
    u = x−(b>>n);
    v = y+(b>>n);
} else {
    u = x+(b>>n);
    v = y−(b>>n);
}
x = u;
y = v;
```

The primary difference in the two possible code paths is the addition or subtraction operation between x or y and the shifted value of b. This code is derived from the mathematical description shown below, which is a common mathematical idiom to compactly describe alternation of addition and subtraction.

x₍ᵢ₊₁₎=xᵢ−yᵢ*dᵢ*2⁻ⁱ

yᵢ₊₁=yᵢ+xᵢ*dᵢ*2⁻ⁱ

where dᵢ=−1 if (zᵢ<0) (see programming construct above for the example of the non-indexed case), and 1 otherwise. In this formation, the multiplication by dᵢ is used to alter the operation between addition or subtraction based on an input value (zᵢ).

The instruction PADDSUB is a dual-function, predicate-controlled instruction that performs either addition or subtraction based on a predicate value and is well-suited for implementing the CORDIC algorithms. Such an instruction can be defined on various numeric datatypes (e.g., integer, floating point, etc.) just as the MINMAX instruction is defined.

Using PADDSUB instructions, according to an embodiment of the invention, to implement the complex functions supported by CORDIC algorithms has similar performance advantages as those shown in the MINMAX instruction. For example, the code segment above would use only two PADDSUB instructions, instead of four ADD and SUB instructions with branch instructions.

As set forth herein, there have been described techniques for pairing instructions into dual-function instructions whose operation is controlled by a predicate value. The described pairing improves performance of certain computational kernels that are known to be computationally demanding. Two examples of dual-function instructions have been described that enhance sorting and the computation of complex functions. As persons skilled in the art will appreciate, the implementations and examples described herein in no way limit the scope of the present invention.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the foregoing is directed to embodiments of the present invention, other and further embodiments of the invention may be devised without departing from the basic scope thereof, and the scope thereof is determined by the claims that follow.

1. A method for executing a multi-function instruction in a processing unit, the method, comprising:
receiving a first plurality of arguments to use with the multi-function instruction;
receiving a predicate value that identifies at least one function of the multi-function instruction;
performing the at least one function on the first plurality of arguments to generate a result;
storing the result in a memory for later use.

2. The method of claim 1, wherein each function of the multi-function instruction presents a substantially similar computational load on the processing unit.

3. The method of claim 1, wherein each function of the multi-function instruction is implemented in an algorithm.

4. The method of claim 1, wherein the predicate value identifies at least two functions of the multi-function instruction that are performed on the first plurality of arguments to generate at least two results.

5. The method of claim 1, wherein the multi-function instruction comprises a dual-function instruction.

6. The method of claim 5, wherein the dual function instruction identifies a minimum and a maximum of the plurality of arguments.

7. The method of claim 5, wherein the dual function instruction performs a sum operation and difference operation involving the plurality of arguments.

8. The method of claim 5, wherein the dual-function instruction performs a binary shift left operation and shift right operation involving the plurality of arguments.

9. The method of claim 1, wherein processing unit comprises a CPU or a GPU.

10. A computer-readable medium including instructions that, when executed by a processing unit, cause the processing unit to execute a multi-function instruction, by performing the steps of:
receiving a first plurality of arguments to use with the multi-function instruction;
receiving a predicate value, that identifies at least one function of the multi-function instruction;
performing the at least one function on the first plurality of arguments to generate a result;
storing the result in a memory for later use.

11. The computer-readable medium of claim 10, wherein each function of the multi-function instruction presents a substantially similar computational load on the processing unit.

12. The computer-readable medium of claim 1, wherein each function of the multi-function instruction is implemented in an algorithm.

13. The computer-readable medium of claim 10, wherein the predicate value identifies at least two functions of the multi-function instruction that are performed on the first plurality of arguments to generate at least two results.

14. The computer-readable medium of claim 10, wherein the multi-function instruction comprises a dual-function instruction.

15. The computer-readable medium of claim 14, wherein the dual function instruction identifies a minimum and a maximum of the plurality of arguments.

16. The computer-readable medium of claim 14, wherein the dual function instruction performs a sum operation and difference operation involving the plurality of arguments.

17. The computer-readable medium of claim 14, wherein the dual-function instruction performs a binary shift left operation and shift right operation involving the plurality of arguments.

18. The computer-readable medium of claim 10, wherein the processing unit comprises a CPU or a GPU.

19. A computing device comprising:
a data bus;
a memory unit coupled to the data bus;
a processing unit coupled to the data bus and configured to
receive a first plurality of arguments to use with a the multi-function instruction;
receive a predicate value, that identifies at least one function of the multi-function instruction;
perform the at least one function on the first plurality of arguments to generate a result;
store the result in the memory unit for later use.

20. The computing device of claim 19, wherein the memory includes instructions that, when executed by the processing unit, cause the processing unit to receive the plurality of arguments, receive the predicate value, perform the at least one function, and store the result.
